(19) United States
(12) Patent Application Publication
(10) Pub. No.: US 2017/0211304 A1
(43) Pub. Date: Jul. 27, 2017

(54) DOMESTIC REFRIGERATOR HAVING A CLOSING CAM WHICH HAS A COUPLING PROJECTION WITH A RECESS

(71) Applicant: BSH HAUSGAERETE GMBH, MUNICH (DE)

(72) Inventors: SHIZENG FANG, GIENGEN (DE); KLAUS FLINNER, ZOESCHINGEN (DE); ALEXANDER GOERZ, AALEN (DE); ALFRED RAAB, HUETTLINGEN (DE)

(21) Appl. No.: 15/328,101

(22) PCT Filed: Jul. 24, 2015
(86) PCT No.: PCT/EP2015/066961

§ 371 Date: Jan. 23, 2017

(30) Foreign Application Priority Data
Jul. 25, 2014 (DE) 10 2014 214 635.6

(51) Int. Cl. E05D 11/10; F25D 23/02; E05D 7/081

(52) U.S. Cl. CPC E05D 11/1014; E05D 7/081; F25D 23/028; E05Y 2900/31; F25D 2323/024

(57) ABSTRACT

A domestic refrigerator has a housing and a door pivotably disposed on the housing by way of hinges. At least one hinge has a door closing fitting part on the door side with a closing clip. A bearing element having a closing cam which is coupled to the locking clip in the closed state of the door is formed on the housing. The closing cam has a coupling projection formed, on a coupling contour which faces it in the state in which it is coupled to the locking clip, with a recess in which a projection end piece formed on the locking clip engages in the coupled state.

The present invention relates to a domestic refrigeration appliance with a housing and a door arranged on the housing in such a manner that it can be pivoted by means of hinges, at least one hinge having a door closing fitting part on the door side with a closing clip. A bearing element with a closing cam, which is coupled to the closing clip when the door is in the closed state, is configured on the housing.

A refrigeration appliance with a door leaf is known from WO 03/018945 A1, said door leaf being supported on the base body of the refrigeration appliance in such a manner that it can be pivoted by means of door hinges in order to open and close the storage chamber of the refrigeration appliance. A closing mechanism is assigned to the door hinge, said closing mechanism having a hook-type configuration. During an operation to close the door leaf, a user first pivots the open door leaf to just before the final closing position. In this position a protrusion on the hook-type elastic closing mechanism comes into contact with a fitting part of the door hinge connected in a fixed manner to the base body. This happens in such a manner that a spring force of the hook-type closing mechanism automatically pushes the door leaf into the final closing position. The door hinge has a fastening block with a continuous receiving slot on an end face of the door leaf. A rectangular fastening segment of the hook-type closing mechanism can be inserted into the receiving slot from one side or an opposite side depending on the hinge side and can be fastened therein by means of a central screw. To form the receiving slot it is necessary for the structural height of the fastening block on the door leaf side to be much larger than the thickness of the closing mechanism. The use of a single screw to fasten the closing mechanism on the end face of the door leaf means that the hook-type closing mechanism can still execute an unwanted rotational movement about the screw to a certain degree.

With known domestic refrigeration appliances independent closing can only take place to a limited degree from a defined angle and therefore from a defined door position. Also with known domestic refrigeration appliances a relatively forceful closing of the door can give rise to the problem that the door springs open again, in particular such that the door does not then close again independently due to the inadequate closing system.

It is the object of the present invention to create a domestic refrigeration appliance with improved door closing.

This object is achieved by a domestic refrigeration appliance having the features set out in claim 1.

An inventive domestic refrigeration appliance comprises a housing and a door, which is arranged on the housing in such a manner that it can be pivoted by means of hinges. At least one hinge has a door closing fitting part on the door side. A bearing element with a closing cam is configured on the housing, the closing cam being coupled to the closing clip when the door is in the closed state. One important concept of the invention is that the closing cam has a coupling projection, which has a recess on a coupling contour that is facing when coupled to the closing clip, in which recess a projection end piece formed on the closing clip engages in the coupled state. Such an embodiment of the coupling elements means that when the door is closed quite forcefully with the result that the door springs open again to a certain degree, the door closes again independently even after springing open again slightly in this manner due to the new closing system. This quite specific embodiment of the coupling contour with a recess means that the projection end piece can move back into the recess even when it has been moved out of the recess slightly and as a result can bring about such automatic and complete closing. More reliable independent closing is also achieved when the door is only opened slightly at a small angle during a closing movement, as the embodiment of the coupling contour with the recess means that the projection end piece of the closing clip is then better able to slide independently into the recess from this critical angle.

Provision is preferably made for the coupling contour of the recess to be configured without corners. The advantages mentioned above are further favored by this, and jamming and catching are prevented. It is also possible to achieve an embodiment of the coupling apparatus with the projection end piece and recess that is more resistant to wear and remains functional in the long term.

Provision is preferably made for the projection end piece to have a corner-free contour on its side facing the recess. This also further promotes the advantages set out above and a very continuous and therefore smooth mechanical coupling can take place between the projection end piece and the recess over almost the entire coupling path.

Provision is preferably made for the coupling contour to have a concave curvature to configure the recess. This means that an inwardly configured bend or depression is shaped as it were quite specifically so that, when coupled to the recess, the projection end piece also latches therein and is held to a certain degree, thereby preventing independent detachment.

Provision is preferably made for the recess to be configured to hold the projection end piece with a close fit at least in parts. This ensures that the projection end piece sits snugly in the recess in the coupled end state, thereby improving the advantages set out above.

Provision is preferably made for the closing clip to be arranged in a resilient manner on the door closing fitting part. Such individual specific deformation elasticity improves the coupling of the closing clip to the closing cam, allowing easier and smoother mechanical connection here too.

Provision is preferably made for the door closing fitting part to be arranged on a lower narrow face of the door. In addition to improved closing behavior the invention also allows the effect of springing open again when the door is closed quite forcefully to be significantly reduced. The specific shaping of the coupling contour of the closing cams reduces the strain on the closing hook or projection end piece of the closing clip when the door is in the closed state. It also allows the closed door to be held in the closed state more efficiently.

Further features of the invention will emerge from the claims, the figures and the description of the figures. The features and feature combinations set out above in the description and the features and feature combinations set out below in the description of the figures and/or shown in the figures alone can be used not only in the combination specified in each instance but also in other combinations or alone without departing from the scope of the invention. Therefore embodiments of the invention, which are not specifically shown and described in the figures but emerge and can be generated by means of separate feature combinations from the described embodiments, should also be considered to be included and disclosed.

One exemplary embodiment of the invention is described in more detail below with reference to schematic drawings, in which:

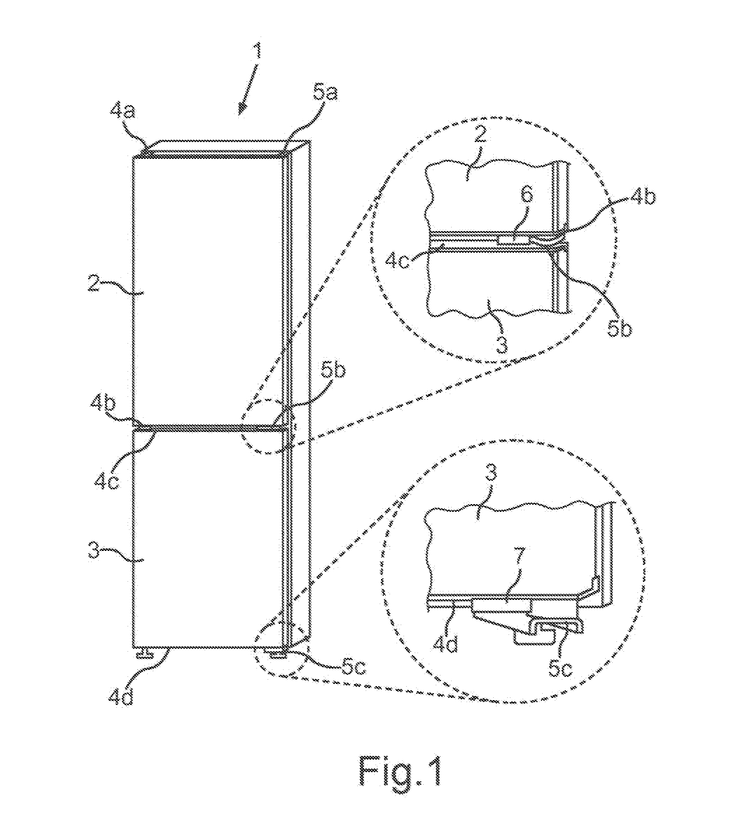

FIG. 1 shows a perspective front view of an exemplary embodiment of an inventive domestic refrigeration appliance with door closing fitting parts on an upper door and a lower door of the domestic refrigeration appliance shown enlarged;

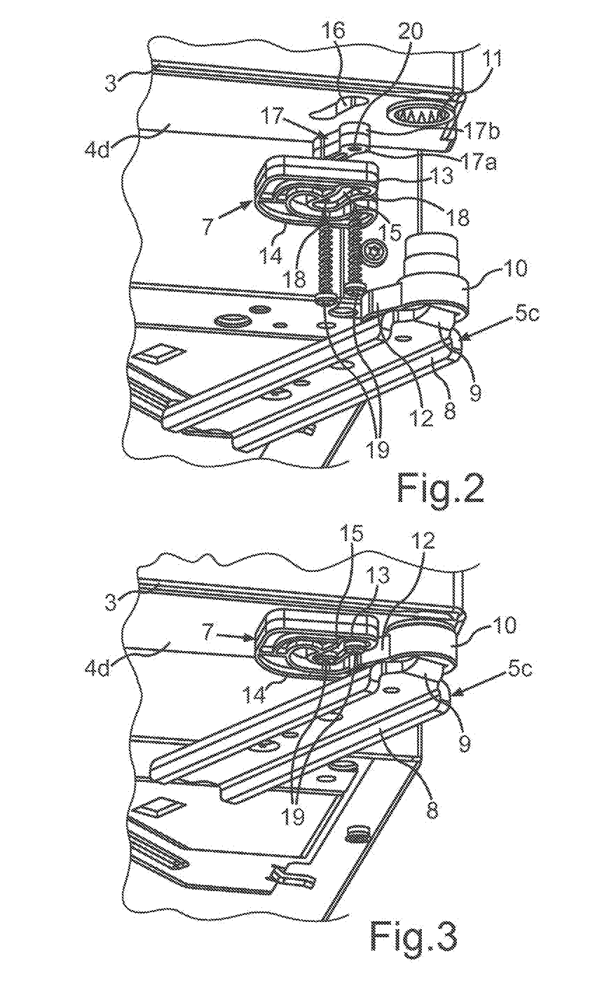

FIG. 2 shows a perspective exploded view of the door closing fitting part on the lower door of the domestic refrigeration appliance according to FIG. 1;

FIG. 3 shows a perspective exploded view of the door closing fitting part on the lower door of the domestic refrigeration appliance according to FIG. 1;

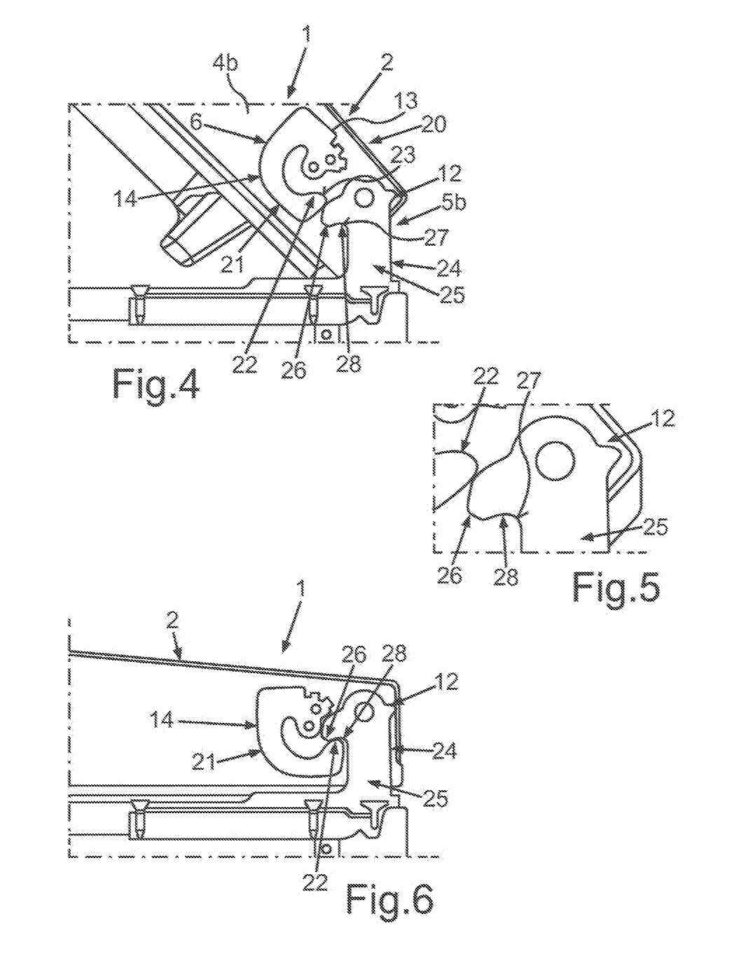

FIG. 4 shows a view from below of the domestic refrigeration appliance with the door open and a diagram of components of a closing system;

FIG. 5 shows an enlarged diagram of a partial detail in FIG. 4; and

FIG. 6 shows a view from below of the domestic refrigeration appliance with the door closed completely in contrast to FIGS. 4 and 5.

Identical elements or elements of identical function are shown with identical reference characters in the figures.

FIG. 1 shows a domestic refrigeration appliance 1 which has an inner container, the walls of which delimit a storage chamber or receiving chamber for food. The domestic refrigeration appliance 1 has an upper door 2 and a second door 3 arranged below it in a vertical direction or in the heightwise direction of the domestic refrigeration appliance 1. The upper door 2 has an upper end wall 4a and a lower end wall 4b and the lower door 3 has an upper end wall 4c, these representing the narrow faces or the upper edge and lower edge of the doors in each instance. In the exemplary embodiment shown the two doors 2 and 3 are configured as doors that are hinged on the right, meaning that the doors 2 and 3 are opened manually with a pivot movement from left to right.

The domestic refrigeration appliance 1 also has door hinges 5a, 5b and 5c, which support the respective door leaf or the door 2, 3 in a pivotable manner. The door hinges 5a, 5b and 5c are configured to support the respective door 2, 3 in a first position, as shown in FIG. 1, hinged on the right and in a second embodiment (not shown) hinged on the left. As shown in both enlarged details in FIG. 1, a door closing fitting part 6, 7 is assigned to each lower door hinge 5b, 5c of each door 2, 3.

The lower door hinge 5c of the lower door 3 and the associated door closing fitting part 7 are shown in more detail in an exploded view in FIG. 2 and in the assembled state in FIG. 3.

The lower door hinge 5c, which is arranged at the base of the domestic refrigeration appliance 1, has a support 8. The support 8 is connected in a fixed manner to the domestic refrigeration appliance 1. It is therefore fastened to the housing here. The support 8 has an extension 9 that bends away at a right angle. A bearing bush 10 is positioned on, in particular attached to, the extension 9. The bearing bush 10 is formed by a plastic bush in the exemplary embodiment shown. In the mounted state, as shown in FIG. 3, the bearing bush 10 projects into a seat carrier 11 on the lower end wall 4b of the lower door 3, thereby forming a pivot joint of the door hinge 5c. The bearing bush 10 supports a cam-type activator contour in the form of a closing cam 12.

The door closing fitting part 7 of the lower door hinge 5c, which is configured in an identical manner to the door closing fitting part 6 of the door hinge 5b, has a fastening segment 13 and a spring segment 14. The fastening segment 13 is configured for the door closing fitting part 6, 7 to be mounted with both left and right hinges.

To this end the fastening segment 13 of the door closing fitting part 6, 7 has a depression 15 on each opposing side. The end wall 4d of the door 3 also has a cutout 16 configured with the correspondingly same shape, as shown in FIG. 2. The door closing fitting part 7 is fixed to the end wall 4d of the door leaf or the door 3 by means of a separate connecting piece 17. To this end the separate connecting piece 17 has a sub-segment 17a, which is inserted with a form fit optionally into one or the other depression 15 in the fastening segment 13 depending on the mounted position of the door closing fitting part 6, 7. A sub-segment 17b of the connecting piece 17 projecting from the depression 15 engages with a form fit in the cutout 16 in the end wall 4d of the door leaf in the mounted position.

The door closing fitting part 6, 7 is configured as an identical part for optional hinging on the right or left. The depressions 15 provided on the fastening segment 13 mean that the door closing fitting part 6, 7 can be particularly narrow. This means that the structural height of the door closing fitting part 6, 7 is very small. The illustrated door closing fitting part 6, 7 for example only has a structural height of 10 millimeters. This low structural height allows the door closing fitting part 6, 7 also to be mounted in a narrow gap for example between the upper door leaf or the upper door 2 and the lower door leaf or the lower door 3 of the domestic refrigeration appliance 1, as also shown for the door hinge 5b in FIG. 1.

It can also be seen in FIGS. 2 and 3 that the fastening segment 13 of the respectively illustrated door closing fitting part 6, 7 has just two through holes 18 arranged at a distance from one another in the illustrated exemplary embodiment. A screw 19 is inserted into each of the two through holes 18, fixing the door closing fitting part 6, 7 to the respective door 2, 3.

Reference is made below to FIG. 4 to FIG. 6 to describe a closing system 20 of the domestic refrigeration appliance 1 further. To this end FIG. 4 shows a view from below of the domestic refrigeration appliance 1, looking at the narrow face or end wall 4b with the door 2 in the opened state. The abovementioned door closing fitting part 6 is fastened to the door 2 in a fixed position on this lower end wall 4b. This door closing fitting part 6 has the abovementioned fastening segment 13 and the spring segment 14, which is formed by a closing clip 21. A projection end piece 22 with a corner-free outer contour 23 is configured on a front free end of the closing clip 21.

A bearing element 24, having the abovementioned closing cam 12 and retaining web 25, is fastened to the housing 2 in a fixed position. The closing cam 12 has a coupling projection 26. The coupling projection 26 has a recess 28 on a coupling contour 27 that is facing when coupled to the closing clip 21. The projection end piece 22 engages in said recess 28 in the coupled state between the projection end piece 22 and the closing cam 12.

It can be seen that the coupling contour 27 of the recess 28 is also configured without corners. The coupling contour 27 has a concave curvature to form the recess 28. The recess 28 is also configured to hold the projection end piece 22 with a close fit at least in parts.

FIG. 5 shows an enlarged diagram of the closing cam 12 with the recess 28. The dip or depression in the coupling projection 26 formed by the recess 28 is clearly shown.

FIG. 6 shows a view from below like the one in FIG. 4 but FIG. 6 shows the door 2 in the completely closed state. It can also be seen here that the projection end piece 22 engages in said recess 28 and is therefore as it were latched therein to a certain degree or engages behind the coupling projection 26.

### LIST OF REFERENCE CHARACTERS

1 Domestic refrigeration appliance

2 Door

3 Door

4a Upper end wall

4b Lower end wall

4c Lower end wall

4d End wall

5a Door hinge

5b Door hinge

5c Door hinge

6 Door closing fitting part

7 Door closing fitting part

8 Support

9 Extension

10 Bearing bush

11 Seat carrier

12 Closing cam

13 Fastening segment

14 Spring segment

15 Depression

16 Cutout

17 Connecting piece

17a Sub-segment

17b Sub-segment

18 Through holes

19 Screw

20 Closing system

21 Closing clip

22 Projection end piece

23 Outer contour

24 Bearing element

25 Retaining web

26 Coupling projection

27 Coupling contour

28 Recess

1-7. (canceled)

8. A domestic refrigeration appliance, comprising:
a housing;
a door;
hinges pivotally mounting said door to said housing;
at least one of said hinges having a door closing fitting part with a closing clip on a door side and a bearing element with a closing cam disposed on said housing, said closing cam being coupled to said closing clip when said door is closed;
said closing clip being formed with a projection end piece;
said closing cam having a coupling projection and a recess formed in a coupling contour facing towards said closing clip in a coupled state; and
said projection end piece of said closing clip engaging in said recess in the coupled state when said door is closed.

9. The domestic refrigeration appliance according to claim 8, wherein said coupling contour of said recess is configured without corners.

10. The domestic refrigeration appliance according to claim 8, wherein said projection end piece has a corner-free contour on a side thereof facing towards said recess.

11. The domestic refrigeration appliance according to claim 8, wherein said coupling contour has a concave curvature to form said recess.

12. The domestic refrigeration appliance according to claim 8, wherein said recess is configured to hold said projection end piece with a close fit at least in parts.

13. The domestic refrigeration appliance according to claim 8, wherein said closing clip is arranged in a resilient manner on said door closing fitting part.

14. The domestic refrigeration appliance according to claim 8, wherein said door closing fitting part is arranged on a lower end face wall of said door.
